(19) United States
(12) Patent Application Publication
(10) Pub. No.: US 2015/0302834 A1
(43) Pub. Date: Oct. 22, 2015

(54) ADDRESS CONFIGURING METHOD AND DEVICE FOR A PARALLEL DISPLAY CONTROL SYSTEM

(71) Applicant: SHENZHEN SUNMOON MICROELECTRONICS CO., LTD., Shenzhen, Guangdong (CN)

(72) Inventor: Zhaohua LI, Shenzhen (CN)

(21) Appl. No.: 14/353,628

(22) PCT Filed: Dec. 30, 2013
(86) PCT No.: PCT/CN13/90860

§ 371 Date: Apr. 23, 2014

(30) Foreign Application Priority Data
Nov. 22, 2013 (CN) 201310598389.X

(51) Int. Cl. G09G 5/39

(52) U.S. Cl. CPC G09G 5/39; G09G 2310/0202; G09G 2352/00

(57) ABSTRACT

The present invention relates to a lamp controlling field and provides an address configuring method and device for a parallel display control system. The method includes: receiving address data sent from a controller of the parallel display control system by each address data port, each address data port respectively locates on each parallel display unit, each address data port is connected to each other in a step serial connection manner, the address data comprises at least one address data package; intercepting the address data package of the address data that arrives first to the address data port thereof in turn to configure address and generating address data of the intercepted address data package successively according to the sequence of the step serial connection by each address data port; sending the remaining address data of the whole address data package to a next address data port connected serially to the address data port to enable the next address data port to configure address. In the present invention, a plurality of parallel display control unit can be configured in one address configuring operation, thereby improving address configuring efficiency.

### TECHNICAL FIELD

The present invention relates to a lamp control technology field, and particularly to an address configuring method and device for a parallel display control system.

### BACKGROUND

A display control system can be divided into a serial connection type and a parallel connection type base on the topology structure of conventional data transmission. The serial connection type of display control is simpler, but it has a fatal defect that the all latter display control units cannot be controlled if a former display control unit is broken down. This causes big problem to the current market, especially to the LED landscape decoration illumination market. The project contractor needs great expense and energy to the post maintenance. The parallel connection type of display control is more complex, but it has an advantage that can overcome the fatal defect of the display control with the serial connection type, namely if one display control unit is broken, the former and latter display control units connected to the broken display control unit cannot be impacted, thereby reducing maintenance cost of the display control system. Therefore, the parallel display control system is popular in the landscape decoration field.

FIG. 1 is a topology diagram of the serial type display control system of a related art, in which the data is transmitted from front to back.

FIG. 2 is a topology diagram of the parallel type display control system of a related art, in which the display data input ports of all display control units are connected together, and each display control unit receives the same data stream.

In order to enable each parallel display control unit fetch the required data from the same data stream, each parallel display control unit should be coded, namely set address. During the system displays the normal lighting, each parallel display control unit fetches corresponding data from display data stream to display lighting effect according to its address data.

However, in the current market, the address configuration of the parallel display control unit in the parallel display control system mostly are separate configuration way, such as a toggle switch way, that is to say, the operator can only configure address for one parallel display control unit in one address configuring operation. Therefore, due to the large number of the parallel display control units in the project, the operator has great work load for configuring the parallel display control unit, which takes lots of time, reduces address configuring efficiency in project construction and maintenance, and prevent the development of the parallel display control way.

### SUMMARY

The object of the present invention is to provide an address configuring method and device for a parallel display control system for solving the problem of low efficiency in the project construction and maintenance caused by only one parallel display control unit being configured in one address configuring operation.

The embodiment of the present invention is realized by an address configuring method for a parallel display control system. The address configuring method includes:

receiving address data sent from a controller of the parallel display control system by each address data port, wherein each address data port respectively locates on each parallel display unit, each address data port is connected to each other in a step serial connection manner, the address data comprises at least one address data package;

intercepting the address data package of the address data that arrives first to the address data port successively to configure address and generating the address data successively after the interception of the address data package, according to the sequence of the step serial connection by each address data port;

sending the remaining address data of the whole address data to a next address data port connected serially to the address data port to enable the next address data port to configure address.

Another object of the present invention is to provide an address configuring device, comprising:

a receiving unit for receiving address data sent from controller of the parallel display control system by each address data port, wherein each address data port respectively locates on each parallel display control unit, each address data port is connected to each other in a step serial connection manner, the address data comprises at least one address data package;

a configuring unit for intercepting the address data package that arrives first to the address data port successively from the address data to configure address and generating the address data successively after the interception of the address data package, according to the sequence of the step serial connection by each address data port;

a sending unit for sending the remaining address data of the whole address data to a next address data port connected serially to the address data port to enable the next address data port to configure address.

In the embodiment of the present invention, only one parallel display control unit being configured in one address configuring operation is avoid by sending the remaining address data of the whole address dada package to a next address data port connected serially to the address data port to enable the next address data port to configure address after the current address data part is configured, thus enables the operator the operator can configure address for a plurality of parallel display control units in one address configuring operation, thereby improving the address configuring efficiency in project construction and maintenance.

### BRIEF DESCRIPTION OF THE DRAWINGS

In order to clearly describe the technical solutions of the embodiments of the present invention, the accompanied drawings used in the embodiments will be simply described below. It should be understood, the embodiments described here intends to explain the present invention, and do not intend to limit the present invention.

FIG. 1 is a topology graph of a serial type display control system of related art.

FIG. 2 is a topology graph of a parallel type display control system of related art.

FIG. 3 is a flow chart of an address configuring method for a parallel display control system in accordance with an embodiment of the present invention.

FIG. 4 is a preferred topology graph of the parallel display control system in accordance with the embodiment of the present invention.

FIG. 5 is a preferred structure diagram of the plurality of dynamic parity bits and the plurality of constant parity bits in accordance with the embodiment of the present invention.

FIG. 6 is a structure diagram of the address data package in accordance with the embodiment of the present invention.

FIG. 7 is an example schematic diagram of the preferred reset signal in accordance with the present embodiment of the present invention.

FIG. 8 is another example schematic diagram of the preferred reset signal in accordance with the present embodiment of the present invention.

FIG. 9 is block diagram of the structure of an address configuring device in accordance with an embodiment of the present invention.

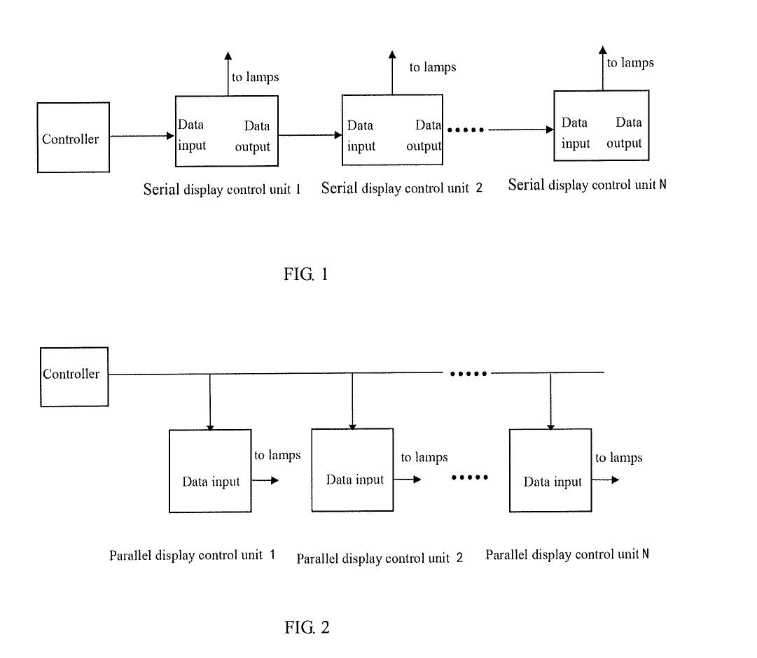

### DETAILED DESCRIPTION OF THE PREFERRED EMBODIMENTS

In order to clearly describe the object, technical solutions, and advantages of the present invention, the accompanied drawings and embodiments are used to describe the present invention in detail. It should be understood, the embodiments described here intends to explain the present invention, and do not intend to limit the present invention.

### A First Embodiment

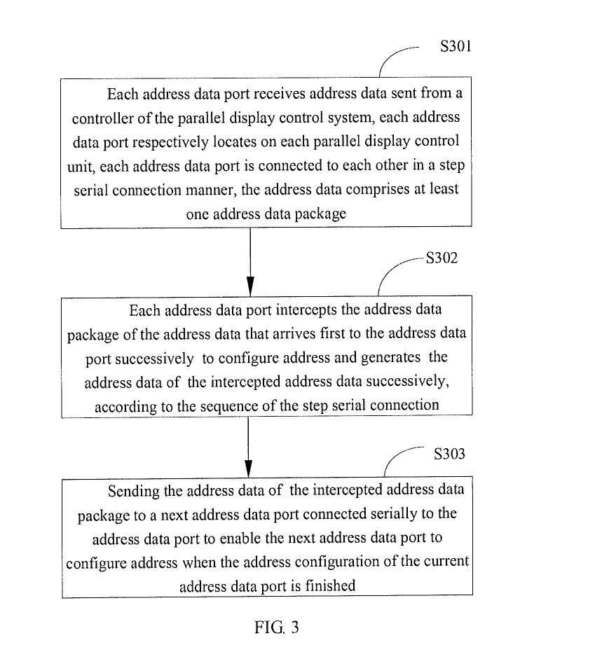

FIG. 3 is a flow chat of an address configuring method for a parallel display control system in accordance with an embodiment of the present invention, which is described in detail below.

In a step S301, each address data port receives address data sent from the controller of the parallel display control system. Each address data port respectively locates on each parallel display control unit, each address data port is connected to each other in a step serial connection manner, the address data comprises at least one address data package.

In the present embodiment, each address data port receives address data sent from the controller of the parallel display control system in turn by means of the address data port.

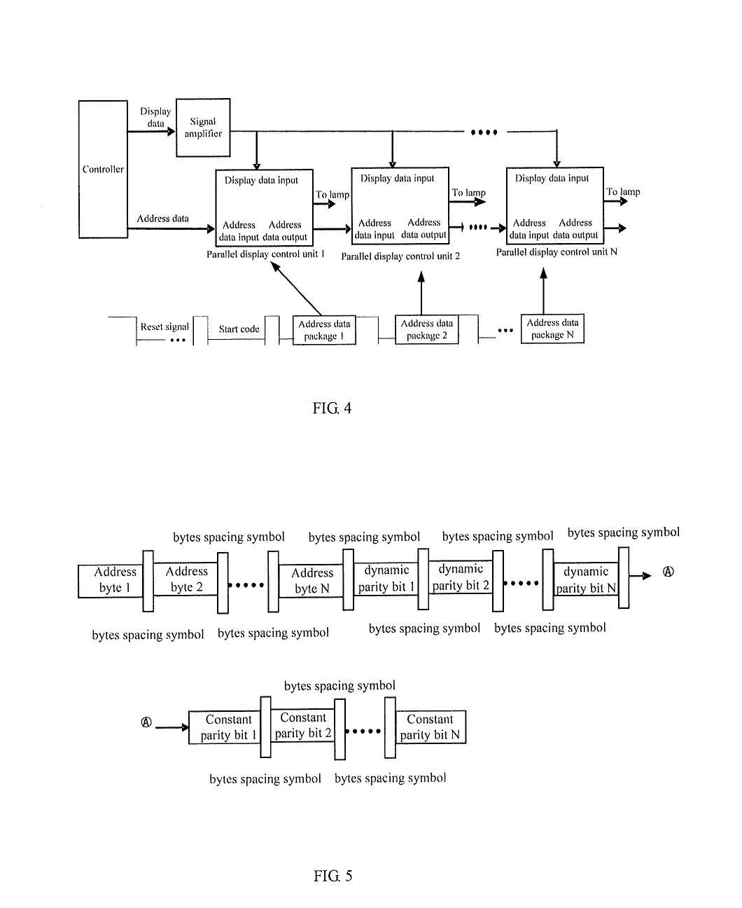

FIG. 4 is a preferred topology graph of the parallel display control system in accordance with the embodiment of the present invention. The parallel display control system comprises a controller, a signal amplifier, a plurality of parallel display control units, and a plurality of lamps being connected to each parallel display control unit.

The controller is connected to the signal amplifier. The signal amplifier is connected to a display data port of each of the plurality of parallel display control unit. The display data port of each of the plurality of parallel display control unit is serially connected. An address data port of each of the plurality of parallel display control unit is parallel connected in a step by step manner, and each parallel display control unit drives a plurality of lamps. The parallel display control system comprises two work states such as an address configuration state and a light effect display state. The address configuration state is that the system writes address data for all the address configuration states by means of an address data stream. The light effect display state is that the system displays predetermined lighting effect by means of a display data stream.

In a step S302, each address data port intercepts the address data package of the address data that arrives first to the address data port successively to configure address and generates the address data successively after the interception of the address data, according to the sequence of the step serial connection.

In the present embodiment, the address data package of the address data arrived first to the address data port thereof is intercepted to configure address. The time of all the address data packages arrived to another address data port can be got according to a clock, the arrived time of all the address data packages are ordered, then the address data package first arrived to the current address data port can be got, thereby the address data packages first arrived to each address data port can be determined.

The process for generating address data after the intercepted address data package will be described below in detail, and will not be described here.

In a step S303, sending the address data after the intercepted address data package to a next address data port connected serially to the address data port to enable the next address data port to configure address when the address configuration of the current address data port is finished.

In the present embodiment, sending the remaining address data of the whole address data to a next address data port connected serially to the address data port to enable the next address data port to configure address when the address configuration of the current address data configuring port is finished.

In the present embodiment, the address data port are serially connected step by step. The operator can control the controller to configure a plurality of parallel display control unit in one address configuring operation, thereby improving the address configuration efficiency in engineering construction and engineering maintenance.

As a preferred embodiment of the present invention, the step of intercepting the address data package of the address data that arrives first to the address data port successively to configure address and generating the address data successively after the intercepted address data successively, according to the sequence of the step serial connection by each address data port includes:

intercepting the address data package of the address data that arrives first to the first address data port among i address data ports to configure address according to the turn of the step serial connection by the first address port, generating address data after the address data package that arrives first to the first address data port, wherein i is an integer larger than or equal to number 1;

intercepting the address data package of the address data that arrives first to the second address data port among i address data ports to configure address, generating address data after the address data package that arrives first to the second address data port by the second address data port;

. . .

until intercepting the address data package of the address data that arrives first to the ith address data port among i address data ports to configure address, generating address data after the address data package that arrives first to the ith address data port by the ith address data port.

In the present embodiment, there are bytes between the address data packages for spacing in order to intercept the address data package.

In the present embodiment, for example, there are 10 address data ports and 10 address data packages sent by the controller. The first address data port intercepts the address data package which arrives first to the first address data port thereof to configure address. After finishing configuring the address, the remaining address data of whole the address data package, namely other 9 address data packages, are sent to the next address data port, namely a second address data port, which is serially connected to the first data port to enable the second address data port to configure address.

The second address data port intercepts the address data package that arrives first to the second address data port from the address data to configure address, and sends the remaining address data of the whole address data, namely 8 address data packages, to the next address data port that is connected serially to the second address data, namely the third address data port, to enable the third address data port to configure data.

By such analogy, until the address data is sent to the last address data port.

As a preferred embodiment of the present invention, the step of intercepting the address data package that arrives first to the first address data port thereof to configure address includes:

intercepting the address data package which arrives first to the first address data port thereof, wherein the address data package includes a plurality of address bits, a plurality of dynamic parity bits, a plurality of constant parity bits;

checking whether the plurality of dynamic parity bits and the plurality of constant parity bits are right;

configuring address by means of the plurality of address bits in the address data package when both of the plurality of dynamic parity bits and the plurality of constant parity bits are right.

In the present embodiment, the address data package is an integral data package corresponding to one address and includes a plurality of address bits, a plurality of dynamic parity bits, a plurality of constant parity bits, and a plurality of bytes spacing symbols.

In the present embodiment, the address bits are the address to be configured. The number of the bits can be set by the size of the system, or by the operator according to the actual situation. For example, 12 bits of address data can represent 4096 addresses, that is to say the 12 bits of address data can configure addresses of 4096 parallel display control units.

In the present embodiment, the dynamic parity bits are the results of doing a predetermined operation to the address bits, namely the data bits of a dynamic parity code. Particularly, the dynamic parity bits are the results of doing a predetermined operation to the first part of the address bits. Different addresses result in different dynamic parity bits.

In the present embodiment, the constant parity bits are data bits of a predetermined constant parity code.

In the present embodiment, checking whether the plurality of dynamic parity bits and the plurality of constant parity bits in the address data package are right.

In the present embodiment, for specifying, the step of checking whether the plurality of dynamic parity bits and the plurality of constant parity bits in the address data package are right is respectively checking whether the plurality of dynamic parity bits in the address data package are right and whether the plurality of constant parity bits in the address data package are right.

Wherein whether the constant parity bits are right is determined by checking whether the plurality of constant parity bits in the address data package are the same as predetermined constant parity bits. The constant parity bits in the address data package are right when the plurality of constant parity bits in the address data package is the same as the predetermined constant parity bits.

FIG. 5 is a preferred structure diagram of the plurality of dynamic parity bits and the plurality of constant parity bits in accordance with the embodiment of the present invention.

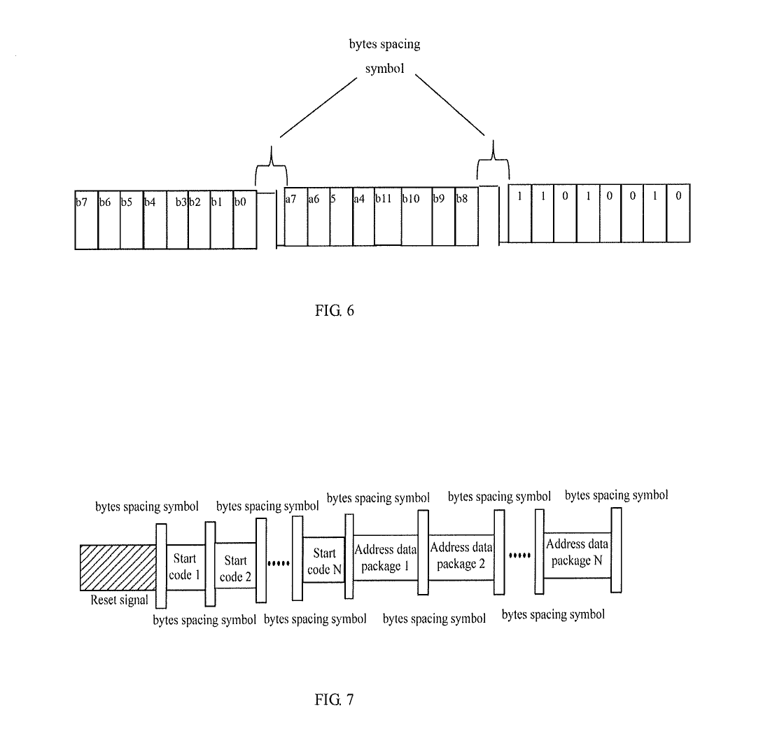

FIG. 6 is a structure diagram of the address data package in accordance with the embodiment of the present invention.

In the present embodiment, the address data package includes 12 bits address bits, 4 bits dynamic parity bits, 8 bits constant parity bits, and 2 bytes spacing symbols.

Wherein, b0-b11 are 12 bits address bits, b0 is the lowest bit, b11 is the highest bit, And 4096 addresses can be configured. The number of the bits of the address bits can be set according to the size of the system.

a7-a4 are 4 bits dynamic parity bits, a7 is a negative code of b11, a6 is a negative code of b10, a5 is a negative code of b9, a4 is a negative code of b8, namely when the dynamic parity bits of the first part of the address bits are negative bits of the second part of the address bits, it indicates that dynamic parity bits in the address data package are right.

The binary code 11010010 is the constant parity bits.

In the present embodiment, during checking the plurality of dynamic parity bits and the plurality of constant parity bits, a plurality of address bits in the address data package are used to configure address when both the plurality of dynamic parity bits and the plurality of constant parity bits are right. In one aspect, the plurality of dynamic parity bits is used to improve the anti-interference ability while configuring address. In another aspect, the plurality of constant parity bits is provided to identify and check different projects to avoid the same address configuration of different projects.

As a preferred embodiment of the present invention, after the step of intercepting the address data package of the address data that arrives first to the address data port successively and before finishing the step of configuring address, the method further comprises:

shielding other address data ports to receive address data package by sending predefined invalid signal to other address data ports, wherein the invalid signal comprises high level signals.

In the present embodiment, intercepting the address data package of the address data which arrives first to the address data port thereof in turn to configure address, each of the intercepted address data package are high level signal, the invalid signal sent to shielding other address data ports comprises high level signals.

In the present embodiment, after the address is finished configuring, stopping sending predefined invalid signal to other address data ports, and stopping shielding other address data ports to receive address data package, and sending the address data after the intercepted address data package to the next address data port to enable the next data port to configure address.

For the convenience of description, for example, 10 address data ports and 10 address data packages sent by the controller are taken for example. The first address data port intercepts the address data package arrived first to the first address data port from the address data to configure address by the input ends of the other address data ports and sends predefined invalid signal to other address data ports in means of the output ends of the other address data ports to shield other address data ports to receive address data package. After the address is finished configuring, the first address data port stops sending predefined invalid signal to other address data ports, and stops shielding other address data ports to receive address data package, and send the address data after the intercepted address data package, namely 9 address data packages, to the next address data port, namely the second address data port, to enable the second address data port to configure address.

The second address data port intercepts the address data package arrived first to the second address data port from the address data to configure address by the input ends of the other address data ports and sends predefined invalid signal to other address data ports in means of the output ends of the other address data ports to shield other address data ports to receive address data package. After the address is finished configuring, the first address data port stops sending predefined invalid signal to other address data ports, and stops shielding other address data ports to receive address data package, and send the remaining address data of the whole address data, namely 8 address data packages, to the next address data port, namely the third address data port, to enable the second address data port to configure address. By such analogy, until the address data is sent to the last address data port.

In the present embodiment, only the address data port currently configured can obtain the address data package by shielding the other address data ports. After finishing configuring the address, the remaining address data of the whole address data are sent to the next address data port, which is serially connected to the second data port, to enable the next address data port to configure address.

As a preferred embodiment of the present invention, before the step of receiving address data sent from controller of the parallel display control system by each address data port, the method further comprises:

implementing the step of receiving address data sent from the controller of the parallel display control system by each address data port when each address data port receives protocol reset signal sent by the controller of the parallel display control system, the protocol reset signal comprises low level signal.

In the present embodiment, the low level signal being continually not less than 500 mS is taken as the protocol reset signal, each address data port receives the address data sent by the controller of the parallel display control system.

In the present embodiment, the protocol reset signal ends with the bytes spacing symbols and sends start codes with a plurality of bytes. For example, binary number 110 is taken as the bytes spacing symbol, binary number 00000000 is taken as the start code, a receiving device determines the rates of the communication of this time in the range of 150 Kbit/s˜2 Mbit/s according to the receiving time of the start codes, in order to select right decoding clock for the later decoding process.

FIG. 7 is an example schematic diagram of the preferred reset signal in accordance with the present embodiment of the present invention.

FIG. 8 is another example schematic diagram of the preferred reset signal in accordance with the present embodiment of the present invention.

In the present embodiment, the protocol reset signal and the start code are simultaneously sent to all the parallel display control units to set the functions and rates of the parallel display control units.

As a preferred embodiment of the present invention, a plurality of address data packages are set inside the automatic address data configuration protocol. The automatic address data configuration protocol further includes a reset signal, a plurality of start codes, and a plurality of bytes spacing symbols. Wherein, the address data package includes a plurality of address bits, a plurality of dynamic parity bits, a plurality of constant parity bits, and a plurality of bytes spacing symbols.

In the embodiment, the constant level keeping for a predetermined time is taken as the protocol reset signal to remind the receiving device to receive data. The reset signal ends with the bytes spacing symbols and then the plurality of start codes are sent to the receiving device. The number in each bit of the start code is a preset number, the receiving device implements corresponding function set according to the start code, and determines the rates of the communication of this time in the range of 250 Kbit/s˜2 Mbit/s according to the receiving time of the start codes, in order to select right decoding clock for the later decoding process. The plurality of address data package follows the start codes, each address data package is configured one address, and each receiving device receives one address data package.

In the present embodiment, the transmission of the above described protocols can be a differential transmission way of balanced signals or a TTL level transmission way of unbalanced signals.

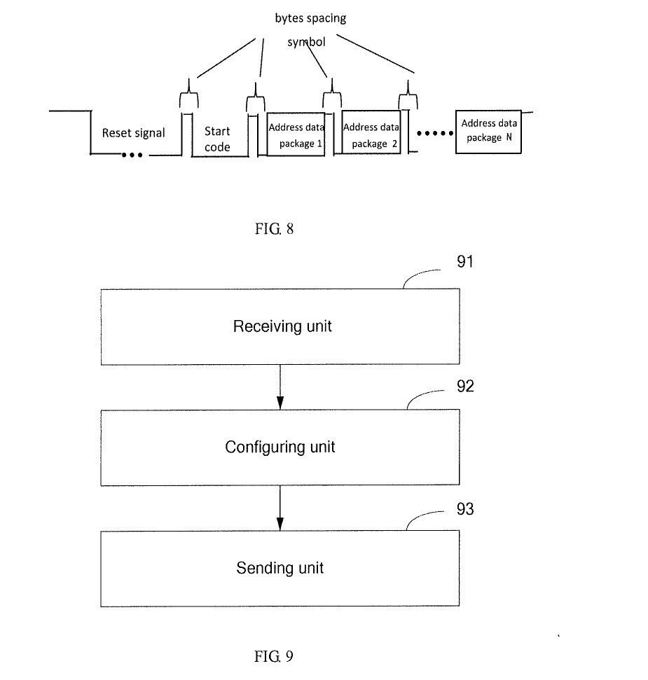

FIG. 9 is a block diagram of the structure of an address configuring device in accordance with an embodiment of the present invention. The address configuring device runs in clients of the parallel display control system, includes but are not limited to parallel display devices. For the convenience of description, only the parts related to the present embodiment are shown.

Referring to FIG. 9, the address configuring device includes a receiving unit 91 for receiving address data sent from a controller of the parallel display control system by each address data port, wherein each address data port respectively locates on each parallel display control unit, each address data port is connected to each other in a step serial connection manner, the address data comprises at least one address data package;

a configuring unit 92 for intercepting the address data package of the address data that arrives first to the address data port successively to configure address and generating remaining address data of the whole address data package successively, according to the sequence of the step serial connection by each address data port;

a sending unit 93 for sending the intercepted address data to a next address data port connected serially to the address data port to enable the next address data port to configure address.

The configuring unit 92 of the address configuring device further includes:

a first generating sub-unit for intercepting the address data package of the address data that arrives first to the first address data port among i address data ports to configure address according to the sequence of the step serial connection by the first address port, generating address data after the address data package that arrives first to the first address data port, wherein i is an integer larger than or equal to number 1;

a second generating sub-unit for intercepting the address data package of the address data that arrives first to the second address data port among i address data ports to configure address, generating the remaining address data of the whole address data by the second address data port;

. . .

an ith generating sub-unit for intercepting the address data package of the address data that arrives first to the ith address data port among i address data ports to configure address, generating remaining address data of the whole address data by the ith address data port.

The configuring unit 92 further includes:

an intercepting sub-unit for intercepting the address data package of the address data that arrives first to the address data port thereof, wherein the address data package comprises a plurality of address bits, a plurality of dynamic parity bits, a plurality of constant parity bits;

a checking sub-unit for checking whether the plurality of dynamic parity bits and the plurality of constant parity bits are right;

a configuring sub-unit for configuring address by means of the plurality of address bits in the address data package when both of the plurality of dynamic parity bits and the plurality of constant parity bits are right.

The device further comprises:

a shielding unit for shielding other address data ports to receive address data package by sending predefined invalid signal to other address data ports, wherein the invalid signal comprises high level signals.

The device further comprises:

an implementing unit for implementing the step of receiving address data sent from the controller of the parallel display control system by each address data port when each address data port receives protocol reset signal sent by the controller of the parallel display control system, the protocol reset signal comprises a low level signal.

The address configuring device provided in the present embodiment of the present invention can be applied to the method embodiment described above, the detailed description of the method refers to the embodiment described above and is not repeated here.

The above described examples are only a few embodiments of the present invention, and the descriptions are detailed, but it should not be understood that they are intended to limit the invention to these embodiments. It should be noted that, to the person skilled in this art, the alternatives, modifications and equivalent to the embodiments may be included within the spirit and scope of the invention.

1. An address configuring method for a parallel display control system, comprising:
receiving address data sent from a controller of the parallel display control system by each address data port, wherein each address data port respectively locates on each parallel display unit, each address data port is connected to each other in a step serial connection manner, the address data comprises at least one address data package;
intercepting the address data package of the address data that arrives first to the address data port successively to configure address and generating address data successively after the intercepted address data package successively, according to the turn of the step serial connection by each address data port;
sending the address data of the intercepted address data package to a next address data port connected serially to the address data port to enable the next address data port to configure address.

2. The method as claimed in claim 1, wherein the step of intercepting the address data package of the address data that arrives first to the address data port successively to configure address and generating intercepted address data in turn according to the turn of the step serial connection by each address data port comprises:
intercepting the address data package of the address data that arrives first to the first address data port among i address data ports to configure address according to the sequence of the step serial connection by the first address port, generating address data of the intercepted address data package that arrives first to the first address data port, wherein i is an integer larger than or equal to number 1;
intercepting the address data package that arrives first to the second address data port among i address data ports from the address data to configure address, generating the remaining address data of the whole address data to the second address data port by the second address data port;
. . .
until intercepting the address data package that arrives first to the ith address data port among i address data ports from the address data to configure address, generating the remaining address data of the whole address data to the ith address data port by the ith address data port.

3. The method as claimed in claim 1, wherein the step of intercepting the address data package of the address data that arrives first to the address data port thereof to configure address comprises:
intercepting the address data package of the address data that arrives first to the address data port thereof, wherein the address data package comprises a plurality of address bits, a plurality of dynamic parity bits, and a plurality of constant parity bits;
checking whether the plurality of dynamic parity bits and the plurality of constant parity bits are right;
configuring address by means of the plurality of address bits in the address data package when both of the plurality of dynamic parity bits and the plurality of constant parity bits are right.

4. The method as claimed in claim 1, wherein after the step of intercepting the address data package of the address data that arrives first to the address data port thereof and before finishing the step of configuring address, the method further comprises:
shielding other address data ports to receive address data package by sending predefined invalid signal to other address data ports, wherein the invalid signal comprises high level signals.

5. The method as claimed in claim 1, wherein before the step of receiving address data sent from the controller of the parallel display control system by each address data port, the method further comprises:
implementing the step of receiving address data sent from the controller of the parallel display control system by each address data port when each address data port receives protocol reset signal sent by the controller of the parallel display control system, the protocol reset signal comprises low level signal.

6. An address configuring device, comprising:
a receiving unit for receiving address data sent from the controller of the parallel display control system by each address data port, wherein each address data port respectively locates on each parallel display control unit, each address data port is connected to each other in a step serial connection manner, the address data comprises at least one address data package;
a configuring unit for intercepting the address data package that arrives first to the address data port successively from the address data to configure address and generating the address data successively after the intercepted address data package successively, according to the sequence of the step serial connection by each address data port;
a sending unit for sending the address data after the intercepted address data package to a next address data port connected serially to the address data port to enable the next address data port to configure address.

7. The device as claimed in claim 6, wherein the configuring unit further comprises:
a first generating sub-unit for intercepting the address data package that arrives first to the first address data port among i address data ports form the address data to configure address according to the sequence of the step serial connection by the first address port, generating address data after the address data package that arrives first to the first address data port, wherein i is an integer larger than or equal to number 1;
a second generating sub-unit for intercepting the address data package that arrives first to the second address data port among i address data ports from the address data to configure address, generating the address data successively of the intercepted address data package that arrives first to the second address data port by the second address data port;
. . .
an ith generating sub-unit for intercepting the address data package that arrives first to the ith address data port among i address data ports from the address data to configure address, generating address data successively after of the intercepted address data package that arrives first to the ith address data port by the ith address data port.

8. The device as claimed in claim 6, wherein the configuring unit further comprises:
an intercepting sub-unit for intercepting the address data package of the address data that arrives first to the address data port thereof, wherein the address data package comprises a plurality of address bits, a plurality of dynamic parity bits, and a plurality of constant parity bits;
a checking sub-unit for checking whether the plurality of dynamic parity bits and the plurality of constant parity bits are right;
a configuring sub-unit for configuring address by means of the plurality of address bits in the address data package when both of the plurality of dynamic parity bits and the plurality of constant parity bits are right.

9. The device as claimed in claim 8, further comprises:
a shielding unit for shielding other address data ports to receive address data package by sending predefined invalid signal to other address data ports, wherein the invalid signal comprises high level signals.

10. The device as claimed in claim 6, further comprises:
an implementing unit for implementing the step of receiving address data sent from the controller of the parallel display control system by each address data port when each address data port receives protocol reset signal sent by the controller of the parallel display control system, the protocol reset signal comprises a low level signal.
